(19) United States
(12) Patent Application Publication
(10) Pub. No.: US 2022/0411613 A1
(43) Pub. Date: Dec. 29, 2022

(54) SULFUR-CROSS-LINKABLE RUBBER BLEND AND PNEUMATIC VEHICLE TIRE

(71) Applicant: Continental Reifen Deutschland GmbH, Hannover (DE)

(72) Inventors: Christoph Eichhorst, Hanau (DE); Marion Puppa, Hannover (DE); Catarina Sà, Isernhagen (DE); Dieter Jeromin, Hannover (DE); Viktoria Pavon Sierra, Hannover (DE); Pedro-Nuno Rodrigues, Isernhagen (DE); Jakob Hey, Gehrden (DE)

(73) Assignee: Continental Reifen Deutschland GmbH, Hannover (DE)

(21) Appl. No.: 17/756,717

(22) PCT Filed: Oct. 27, 2020
(86) PCT No.: PCT/EP2020/080142

§ 371 Date: Jun. 1, 2022

(30) Foreign Application Priority Data
Dec. 9, 2019 (DE) 10 2019 219 145.2

(51) Int. Cl. C08L 9/06; B60C 1/00; C08L 7/00

(52) U.S. Cl. CPC C08L 9/06; B60C 1/0016; B60C 1/0041; B60C 1/0025; C08L 7/00; B60C 2001/005; B60C 2001/0075

(57) ABSTRACT

The invention relates to a sulfur-crosslinkable rubber mixture and to a pneumatic vehicle tire comprising at least one rubber component made of the sulfur-vulcanized rubber mixture.

The rubber mixture contains
10-60 phr (parts by weight, based on 100 parts by weight of the total rubbers in the mixture) of at least one functionalized polybutadiene A,
   wherein the functionalized polybutadiene A is functionalized at one chain end with an organosilyl group containing amino groups and/or ammonium groups,
   and wherein the functionalized polybutadiene A is functionalized at the other chain end with an amino group,
up to 90 phr of at least one further diene rubber and
30-350 phr of at least one filler.

The invention relates to a sulfur-crosslinkable rubber mixture and to a pneumatic vehicle tire comprising at least one rubber component made of the sulfur-vulcanized rubber mixture.

Since the running properties of a tire, especially a pneumatic vehicle tire, depend to a great extent on the rubber composition of the tread, particularly high demands are placed on the composition of the tread mixture. For this reason, various attempts have been made to positively influence the properties of the tire through the variation of the polymer components, the fillers and the other admixtures in the tread mixture. It has to be taken into account here that an improvement in one tire property often brings a deterioration in another property; for instance, an improvement in rolling resistance is typically associated with a deterioration in braking characteristics. Other components of the tire also affect the rolling resistance of the tire.

One known way of influencing tire properties such as abrasion, wet skid characteristics and rolling resistance is, for example, to use solution-polymerized styrene-butadiene copolymers with different microstructure. In addition, it is possible to modify styrene-butadiene copolymers by, for example, varying the styrene and vinyl contents, or implementing end group modifications, couplings or hydrogenations. The various types of copolymer have a different effect on the vulcanizate properties and hence also on the tire properties.

EP 3 150 403 A1 describes silica-containing rubber mixtures for tires having low rolling resistance, containing solution-polymerized styrene-butadiene copolymers that have been functionalized at least at one chain end with alkoxysilyl groups containing amino groups and with a further group selected from the group consisting of alkoxysilyl groups and amino group-containing alkoxysilyl groups.

The reason for the reduction in rolling resistance is presumed to be an enhanced filler-polymer interaction.

EP 3 150 402 A1, EP 3 150 401 A1, DE 10 2015 218 745 A1 and DE 10 2015 218 746 A1 also describe solution-polymerized styrene-butadiene copolymers that have been functionalized at least at one chain end with alkoxysilyl groups containing amino groups and with a further group selected from the group consisting of alkoxysilyl groups and amino group-containing alkoxysilyl groups. They are used in combination with different further admixtures of the rubber mixtures.

EP 2 703 416 A1 discloses modified solution-polymerized styrene-butadiene copolymers and the preparation and use thereof in tires. The styrene-butadiene copolymers have nitrogen-containing groups (amino group-containing organosilyl groups) that were protected with protecting groups in the preparation of the polymers. The rubber mixtures with such styrene-butadiene copolymers are said to feature a balanced ratio of processibility, wet grip and low hysteresis.

EP 2 853 558 A1 describes styrene-butadiene rubbers functionalized with phthalocyanine groups and/or hydroxyl groups and/or epoxy groups and/or silane-sulfide groups, wherein the styrene content of the styrene-butadiene rubber may be 0% by weight. In the case of a styrene content of 0% by weight, the polymer is a polybutadiene. The rubber mixtures have improvements in rolling resistance and abrasion.

It is an object of the invention to provide rubber mixtures that have further-improved damping characteristics and hence lead to improved rolling resistance when used as rubber mixture for pneumatic vehicle tires. At the same time other properties of the rubber mixture shall be negatively affected only to a small extent, if at all.

This object is achieved by a rubber mixture comprising
10-60 phr (parts by weight, based on 100 parts by weight of the total rubbers in the mixture) of at least one functionalized polybutadiene A,

wherein the functionalized polybutadiene A is functionalized at one chain end with an organosilyl group containing amino groups and/or ammonium groups,

and wherein the functionalized polybutadiene A is functionalized at the other chain end with an amino group,
up to 90 phr of at least one further diene rubber and
30-350 phr of at least one filler.

The unit “phr” (parts per hundred parts of rubber by weight) used in this document is the standard unit of quantity for mixture recipes in the rubber industry. The dosage of the parts by weight of the individual substances is always based here on 100 parts by weight of the total mass of all rubbers present in the mixture.

It has been found that, surprisingly, the use of a specifically functionalized polybutadiene in a filler-containing rubber mixture can further improve the damping characteristics of the mixture, visible, for example, by the resilience at 70° C. and the tan δ at 55° C. When such a mixture is used in pneumatic vehicle tires, this leads to an improvement in rolling resistance. When used as a tread mixture, this rubber mixture can also achieve decoupling of the trade-off between rolling resistance and braking characteristics (wet and dry braking).

By virtue of the two different functional groups on the polybutadiene A, it appears possible for interactions of the polymer to take place both with any polar fillers present in the mixture, such as silica, and with any nonpolar fillers present in the mixture.

The functionalized polybutadiene A may be any of the types known to those skilled in the art having a molecular weight M_{w} of 250 000 to 500 000 g/mol. These include so-called high-cis and low-cis types, with polybutadienes (BR) having a cis content of not less than 90% by weight being referred to as high-cis type and polybutadiene having a cis content of less than 90% by weight as low-cis type. An example of a low-cis polybutadiene is Li-BR (lithium-catalyzed butadiene rubber) having a cis content of 20% to 50% by weight. Preferably, the functionalized polybutadiene A is a polybutadiene produced with a lithium catalyst. Particularly good results with regard to improvement in rolling resistance are achieved when the functionalized polybutadiene has a cis content of 25% to 35% by weight, a trans content of 35% to 45% by weight and a vinyl content of 25% to 35% by weight. The functionalized polybutadiene preferably has a molecular weight M_{w} of 250 000 to 500 000 g/mol. The functionalized polybutadiene preferably has a glass transition temperature of −100° C. to −60° C., in order to contribute to good winter properties when used in tires.

The vinyl content of the polymers discussed in the context of the present invention is determined by means of ¹³C NMR (solvent: deuterochloroform CDCl₃, NMR: nuclear magnetic resonance) and comparison with data from infrared spectrometry (IR; FT-IR spectrometer from Nicolet, KBr window of diameter 25 mm×5 mm, 80 mg sample in 5 ml of 1,2-dichlorobenzene). Glass transition temperature (T_{g}) is determined by dynamic scanning calorimetry (DSC) to DIN 53765: 1994-03 or ISO 11357-2: 1999-03, calibrated DSC with low-temperature device, calibration according to instrument type and manufacturer's instructions, sample in aluminum crucible with aluminum lid, cooling to temperatures lower than −120° C. at 10° C./min).

The functionalized polybutadiene A is functionalized at one chain end with an organosilyl group containing amino groups and/or ammonium groups. Such functionalizations can be obtained by reacting the polymer with an amino group-containing alkoxysilyl compound having protecting groups on the amino group. For example, it is possible to use N,N-bis(trimethylsilyl)aminopropylmethyldiethoxysilane. After deprotection, the functionalized polybutadiene A is obtained.

The functionalized polybutadiene A is functionalized at the other chain end with an amino group. The amino groups may be primary, secondary or tertiary amino groups, which may also be in cyclic form. The functionalization can be achieved by adding lithium amides in the polymerization or producing the amides in situ by addition of n-butyllithium and amines, e.g. cyclic amines such as piperidine or piperazines, in the polymerization.

The amino group at the other chain end is preferably a cyclic diamine group. For this purpose, for example, N-(t-butyldimethylsilyl)piperazine may be added in combination with n-butyllithium in the polymerization.

The rubber mixture of the invention contains 10 to 60 phr of at least one functionalized polybutadiene A. It is also possible to use two or more polymers of this type in a blend.

The rubber mixture of the invention also contains up to 90 phr of at least one further diene rubber. Diene rubbers are rubbers which are formed by polymerization or copolymerization of dienes and/or cycloalkenes and thus have C═C double bonds either in the main chain or in the side groups.

The further diene rubbers may, for example, be natural polyisoprene and/or synthetic polyisoprene and/or other polybutadienes (butadiene rubber) than the functionalized polybutadiene A and/or styrene-butadiene copolymer (styrene-butadiene rubber) and/or epoxidized polyisoprene and/or styrene-isoprene rubber and/or halobutyl rubber and/or polynorbornene and/or isoprene-isobutylene copolymer and/or ethylene-propylene-diene rubber. The rubbers may be used as pure rubbers or in oil-extended form.

However, the further diene rubber is preferably selected from the group consisting of natural polyisoprene, synthetic polyisoprene, styrene-butadiene copolymers and further polybutadienes. These diene rubbers have good processibility to give the rubber mixture and result in good tire properties in the vulcanized tires.

The natural and/or synthetic polyisoprene may be either cis-1,4-polyisoprene or 3,4-polyisoprene. However, the use of cis-1,4-polyisoprenes having a cis-1,4 proportion of >90% by weight is preferred. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, the cis-1,4 content in the natural rubber is greater than 99% by weight.

In addition, also conceivable is a mixture of one or more natural polyisoprenes with one or more synthetic polyisoprenes. Natural polyisoprene is understood to mean rubber that can be obtained by harvesting from sources such as rubber trees (Hevea brasiliensis) or non-rubber tree sources (for example guayule or dandelion (e.g. Taraxacum koksaghyz)). Natural polyisoprene (NR) is understood to mean nonsynthetic polyisoprene.

The further polybutadiene may be any of the types known to those skilled in the art having an M_{w} of 250 000 to 500 000 g/mol. These include so-called high-cis and low-cis types, wherein polybutadiene having a cis content of not less than 90% by weight is referred to as high-cis type and polybutadiene having a cis content of less than 90% by weight is referred to as low-cis type. An example of a low-cis polybutadiene is Li-BR (lithium-catalyzed butadiene rubber) having a cis content of 20% to 50% by weight. Particularly good abrasion properties and low hysteresis of the rubber mixture are achieved with a high-cis BR. The further polybutadiene used may be end group-modified with other modifications and functionalizations and/or be functionalized along the polymer chains as the functionalized polybutadiene A. The modifications may, for example, be those with hydroxyl groups and/or ethoxy groups and/or epoxy groups and/or siloxane groups and/or carboxyl groups and/or silane-sulfide groups. Metal atoms may also be a constituent of functionalizations.

The styrene-butadiene rubber (styrene-butadiene copolymer) may be either solution-polymerized styrene-butadiene rubber (SSBR) or emulsion-polymerized styrene-butadiene rubber (ESBR), and it is also possible to use a mixture of at least one SSBR and at least one ESBR. The terms “styrene-butadiene rubber” and “styrene-butadiene copolymer” are used synonymously in the context of the present invention. Preference is given in each case to styrene-butadiene copolymers having an M_{w} of 250 000 to 600 000 g/mol (two hundred and fifty thousand to six hundred thousand grams per mole). The styrene-butadiene copolymer(s) used may likewise have been end group-modified and/or functionalized along the polymer chains with modifications and functionalizations.

The rubber mixture contains 30 to 350 phr of at least one filler. This may comprise fillers such as carbon blacks, silicas, aluminosilicates, chalk, starch, magnesium oxide, titanium dioxide or rubber gels, where the fillers may be used in combination. Additionally conceivable are carbon nanotubes (CNTs, including discrete CNTs, what are called hollow carbon fibers (HCFs) and modified CNTs containing one or more functional groups, such as hydroxyl, carboxyl and carbonyl groups). Graphite and graphenes, and also “carbon-silica dual-phase filler”, are also usable as filler.

If carbon black is present in the rubber mixture, it is possible to use any of the carbon black types known to the person skilled in the art. Preference is given, however, to using a carbon black having an iodine adsorption number to ASTM D 1510 of 30 to 180 g/kg, preferably 30 to 130 g/kg, and a DBP number to ASTM D 2414 of 80 to 200 ml/100 g, preferably 100 to 200 ml/100 g, more preferably 100 to 180 ml/100 g. For the application in the vehicle tire, this achieves particularly good rolling resistance indicators (resilience at 70° C.) combined with other good tire properties. The polybutadiene A can interact with the carbon black with its amino group functionalization.

For reduction of rolling resistance, it has been found to be advantageous when the rubber mixture contains silica as filler. The polybutadiene A can interact with the silica via its organosilyl groups containing amino groups and/or ammonium groups.

It is possible to use a wide variety of different silicas, such as low-surface area or highly dispersible silica, including in a mixture. It is particularly preferable when a finely divided, precipitated silica is used, having a CTAB surface area (to ASTM D 3765) of 30 to 350 m²/g, preferably of 110 to 250 m²/g. Silicas used may be either conventional silicas, such as those of the VN3 type (trade name) from Evonik, or highly dispersible silicas known as HD silicas (e.g. Ultrasil 7000 from Evonik).

The rubber mixture preferably contains 50 to 150 phr of silica in order to achieve good processibility coupled with good tire properties.

For improvement of processibility and for binding of the silica to the diene rubber in silica-containing mixtures, preference is given to using at least one silane coupling agent in amounts of 1-15 phf (parts by weight, based on 100 parts by weight of silica) in the rubber mixture.

The expression phf (parts per hundred parts of filler by weight) used in this text is the conventional unit of quantity for coupling agents for fillers in the rubber industry. In the context of the present application, phf relates to the silica present, meaning that any other fillers present, such as carbon black, are not included in the calculation of the amount of silane coupling agent.

The silane coupling agents react with the surface silanol groups of the silica or other polar groups during the mixing of the rubber/the rubber mixture (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH2 or —Sx- (with x=2-8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. TESPT may for example also be added as a mixture with carbon black (trade name X50S from Degussa). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is also possible to use, for example, silanes that are sold under the NXT® name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

The rubber mixture may also include plasticizers in amounts of 1 to 300 phr, preferably of 5 to 150 phr, more preferably 15 to 90 phr. Plasticizers that can be used include all the plasticizers that are known to those skilled in the art, such as aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL), preferably having a content of polycyclic aromatics of less than 3% by weight according to method IP 346 or rapeseed oil or factices or liquid polymers, such as liquid polybutadiene—including in modified form. The plasticizer(s) is/are preferably added in at least one primary mixing stage in the production of the rubber mixture of the invention.

The rubber mixture can further contain customary additives in customary parts by weight which are added preferably in at least one primary mixing stage during the production of said mixture. These additives include

a) aging stabilizers, for example N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ),

b) activators, for example zinc oxide and fatty acids (e.g. stearic acid) or zinc complexes, for example zinc ethylhexanoate,

c) waxes,

d) masticating aids, for example 2,2′-dibenzamidodiphenyl disulfide (DBD), e) processing aids, for example fatty acid salts, for example zinc soaps, and fatty acid esters and derivatives thereof, and

f) resins, such as an aliphatic or aromatic hydrocarbon resins.

The proportion of the total amount of further additives is 3 to 150 phr, preferably 3 to 100 phr and particularly preferably 5 to 80 phr.

If the rubber mixture is used for internal tire components, called body mixtures, the rubber mixture may also comprise adhesion-improving and/or -promoting substances, such as bonding systems composed of methylene donor and methylene acceptor.

The vulcanization of the rubber mixture is conducted in the presence of sulfur and/or sulfur donors with the aid of vulcanization accelerators, it being possible for some vulcanization accelerators to act simultaneously as sulfur donors. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

It is preferable to use a sulfenamide accelerator selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfenomorpholide (MBS) and/or N-tert-butyl-2-benzothiazylsulfenamide (TBBS).

It is also possible for the rubber mixture to comprise vulcanization retardants.

The sulfur donor substances used may be any sulfur donor substances known to those skilled in the art. If the rubber mixture comprises a sulfur donor substance, it is preferably selected from the group consisting of, for example, thiuram disulfides, for example tetrabenzylthiuram disulfide (TBzTD), tetramethylthiuram disulfide (TMTD) or tetraethylthiuram disulfide (TETD), thiuram tetrasulfides, for example dipentamethylenethiuram tetrasulfide (DPTT), dithiophosphates, for example DipDis (bis(diisopropyl)thiophosphoryl disulfide), bis(O,O-2-ethylhexylthiophosphoryl) polysulfide (e.g. Rhenocure SDT 50®, Rheinchemie GmbH), zinc dichloryldithiophosphate (e.g. Rhenocure ZDT/S®, Rheinchemie GmbH) or zinc alkyldithiophosphate, and 1,6-bis(N,N-dibenzylthiocarbamoyldithio)hexane and diaryl polysulfides and dialkyl polysulfides.

Further network-forming systems such as can be obtained for example under the trade names

Vulkuren®, Duralink® or Perkalink® or network-forming systems as described in WO 2010/049216 A2 can also be used in the rubber mixture. The latter system contains a vulcanizing agent which crosslinks with a functionality of greater than four and at least one vulcanization accelerator.

In the course of production, preference is given to adding to the rubber mixture at least one vulcanizing agent selected from the group consisting of sulfur, sulfur donors, vulcanization accelerators and vulcanizing agents that crosslink with a functionality of greater than four in the final mixing stage. This makes it possible to produce a sulfur-crosslinked rubber mixture from the mixed finished mixture by vulcanization for use in the pneumatic vehicle tire.

The terms “vulcanized” and “crosslinked” are used synonymously in the context of the present invention.

The rubber mixture is produced by the process which is customary in the rubber industry and in which a primary mixture comprising all constituents apart from the vulcanization system (sulfur and vulcanization-influencing substances) is firstly produced in one or more mixing stages. The finished mixture is produced by adding the vulcanization system in a final mixing stage. The finished mixture is processed further, for example, by an extrusion operation and converted to the appropriate shape. This is followed by further processing by vulcanization, wherein sulfur crosslinking takes place due to the vulcanization system added within the context of the present invention.

The rubber mixture is used for the production of pneumatic vehicle tires, such as car, van, truck, motorcycle or bicycle tires.

In the case of a pneumatic vehicle tire, the rubber mixture may be used for a wide variety of different components. According to the invention, the pneumatic vehicle tire has at least one rubber component composed of the rubber mixture of the invention that has been vulcanized (crosslinked) with sulfur. In the case of the tires, it is accordingly also possible for multiple components to be formed from the rubber mixture of the invention.

In the case of a pneumatic vehicle tire, the tread may consist of a single mixture which then contains a functionalized polybutadiene A, optionally a further diene rubber, and a filler. Frequently, however, pneumatic vehicle tires nowadays have a tread with what is called a cap/base construction. What is meant here by “cap” is the part of the tread that comes into contact with the road, being arranged radially on the outside (upper tread portion or tread cap). What is meant here by “base” is the part of the tread which is arranged radially on the inside, and hence does not come into contact with the road in driving operation, or does so only at the end of the tire lifetime (lower tread portion or tread base).

In a preferred configuration of the invention, the rubber component composed of the mixture of the invention is the part of the tread that comes into contact with the road (cap). Here, the reduced damping characteristics of the mixture have a particularly positive effect on rolling resistance, with simultaneous achievement of good braking characteristics with regard to wet and dry braking.

For a reduction in the rolling resistance of a pneumatic vehicle tire, the mixture of the invention may, however, also be used for what are called body components of the pneumatic vehicle tire. These body components include, for example, the rubberizations of the bead core, of the bead covers, of the bead reinforcers, of the belt, of the carcass or of the belt bandages, but also other mixtures close to the strength member, such as apex, squeegee, belt edge cushion, shoulder cushion and undertread.

In the production of the pneumatic vehicle tire, the mixture as a finished mixture prior to vulcanization is shaped to the desired shape and is applied or introduced in the known manner in the production of the green vehicle tire. The green components may also be wound onto a green tire in the form of narrow strips.

Subsequently, the pneumatic vehicle tire is vulcanized under standard conditions.

The invention is now to be elucidated in detail by comparative and working examples that are summarized in tables 1 and 2.

A functionalized polybutadiene A was synthesized according to the following experimental description:

A 5 l autoclave was charged under a nitrogen atmosphere with 2500 g of cyclohexane, 5 g of tetrahydrofuran, 490 g of 1,3-butadiene and 4.2 mmol of N-(t-butyldimethylsilyl)piperazine. The temperature of the reaction mixture was adjusted to 30° C. and, thereafter, a cyclohexane solution containing 2 mmol of n-butyllithium was added to start the polymerization reaction. The polymerization was conducted under adiabatic conditions. A maximum temperature of 90° C. was attained. On attainment of a conversion of 99%, 5 g of 1,3-butadiene was added over the course of 2 min, and the monomers were polymerized for a further 5 min. Subsequently, a solution of 4.46 mmol of N,N-bis(trimethylsilyl)aminopropylmethyldimethoxysilane in cyclohexane was added to the remaining reaction mixture and left to react for 15 min. 3 g of 2,6-di-tert-tert-butyl-p-cresol was added to the resultant polymer solution comprising a polymer based on dienes. The solvent was then removed with the aid of a steam distillation, keeping the pH at 10 with the aid of sodium hydroxide. The remaining functionalized polybutadiene A was dried at a temperature of 110° C. with heating rolls.

This functionalized polybutadiene A thus obtained was used for the inventive mixtures in the tables that follow.

In tables 1 and 2, comparative mixtures are identified by V, and the inventive mixtures by E.

The mixture was produced by the methods customary in the rubber industry under standard conditions in three stages in a laboratory mixer, in which all the constituents apart from the vulcanization system (sulfur and vulcanization-influencing substances) were first mixed in the first mixing stage (primary mixing stage). In the second mixing stage the preliminary mixture was mixed again. By addition of the vulcanization system in the third stage (ready-mixing stage), the finished mixture was produced, with mixing at 90 to 120° C.

Table 1 lists mixtures for different body components of the tire. Mixtures 1 and 2 are suitable, for example, for the side wall, wings, rim strip or apex, and mixtures 3 and 4 for the rubberization of the belt, of the bandage, of the carcass or of the bead reinforcers, and for the squeegee.

The mixtures from table 1 were used to produce test specimens by vulcanization under pressure at 160° C. for 10 minutes ((1)V) and 2(E)) or 15 minutes ((3)V) and 4(E)), and these test specimens were used to ascertain typical material properties by the test methods specified below:
Shore A hardness at room temperature by durometer according to DIN ISO 7619-1
Resilience at 70° C. according to DIN 53 512 as an indicator of rolling resistance (greater value correlates with better rolling resistance in the tire)
Maximum (max) loss factor tan δ from dynamic-mechanical measurement at 55° C. according to DIN 53 513, strain sweep (smaller value correlates with better rolling resistance in the tire)

In addition, some mixtures from table 2 were used to conduct adhesion experiments on brass-coated steel cord (2×0.30 HT) according to ASTM 2229/D1871 without aging (embedding length into the rubberization mixture: 10 mm, pull-out speed: 125 mm/min). The test specimens were heated at 150° C. for 30 min. The pull-out force and coverage were determined.

The measurements ascertained for the aforementioned properties were based on mixtures 1(V) and 3(V) as reference mixtures. The values therefor were equated to 100%. Values smaller than 100° C. reflect a lowering of the measurement compared to the reference value. Values greater than 100° C. reflect an increase in the measurement compared to the reference value.

TABLE 1

| | Unit | 1(V) | 2(E) | 3(V) | 4(E) |
|---|---|---|---|---|---|
| Constituents | | | | | |
| Natural rubber | phr | 50 | 50 | 80 | 80 |
| BR ^{a} | phr | 50 | — | 20 | — |
| Polybutadiene A^{b} | phr | — | 50 | — | 20 |
| Silica | phr | 46 | 46 | 60 | 60 |
| Plasticizer, processing aid, | phr | 15.3 | 15.3 | 21.2 | 21.2 |
| aging stabilizer | | | | | |
| Vulcanization aid | phr | 5 | 5 | 8 | 8 |
| Resorcinol | phr | — | — | 2.5 | 2.5 |
| Hexamethoxymethylmelamine | phr | — | — | 2.5 | 2.5 |
| Accelerator | phr | 3.5 | 3.5 | 1.6 | 1.6 |
| Sulfur | phr | 1.5 | 1.5 | 4.3 | 4.3 |
| Properties | | | | | |
| Shore hardness | % | 100 | 97 | 100 | 99 |
| Resilience at 70° C. | % | 100 | 109 | 100 | 109 |
| tan δ max at 55° C. | % | 100 | 70 | 100 | 86 |
| Steel adhesion (pull-out force) | % | — | — | 100 | 93 |
| Steel adhesion (coverage) | % | — | — | 100 | 101 |

^{a} high-cis polybutadiene, co-polybutadiene, cis content: 96.1% by weight, trans content: 3.4% by weight, vinyl content: 0.5% by weight, unfunctionalized, M_{w} = 497 000 g/mol, Tg = −105° C.
^{b}functionalized polybutadiene A according to experimental description, cis content: 30% by weight, trans content: 40% by weight, vinyl content: 30% by weight, amine functionalization: piperazine group, M_{w} = 361 000 g/mol, Tg = −75° C.

It becomes apparent from the data from table 1 that it is only the presence of the specially functionalized polybutadiene that achieves an increase in the resilience of the vulcanizates at 70° C. or lowering of the loss factor tan δ at 55° C. This correlates with a reduction in the rolling resistance of the tire with a component made from the mixture. At the same time, the other properties remain at a desired high level.

Table 2 lists mixtures for the tread or tread cap of pneumatic vehicle tires. The mixtures were used for the tread cap of tires of the 205/55 R16 size, and tire tests were conducted according to the following test methods:
Rolling resistance: to ISO 28580
Wet braking: ABS braking from 80 km/h, wet asphalt, low p
Dry braking: ABS braking from 100 km/h, dry asphalt, high p

The values ascertained were converted to performance, with standardization of comparative mixtures 5(V) and 7(V) to 100% performance for each property tested. The mixture performances of 6(E) and 8(E) relate to these comparative mixtures. In these figures, values <100% denote a deterioration in the property, whereas values >100% represent an improvement.

TABLE 2

| | Unit | 5(V) | 6(E) | 7(V) | 8(E) |
|---|---|---|---|---|---|
| Constituents | | | | | |
| Natural rubber | phr | 10 | 10 | 60 | 60 |
| Polybutadiene B^{c} | phr | 25 | — | 40 | — |
| Polybutadiene A^{b} | phr | — | 25 | — | 40 |
| SSBR^{d} | phr | 65 | 65 | — | — |
| N339 carbon black | phr | 5 | 5 | — | — |
| N121 carbon black | phr | — | — | 8 | 8 |
| Silica | phr | 120 | 120 | 112 | 112 |
| Plasticizer | phr | 35 | 35 | 82 | 82 |
| Additives | phr | 29.5 | 29.5 | 13.3 | 13.3 |
| Silane coupling | phr | 9 | 9 | 11.4 | 11.4 |
| agent | | | | | |
| Accelerator | phr | 3.9 | 3.9 | 4.1 | 4.1 |
| Sulfur | phr | 1.9 | 1.9 | 1.8 | 1.8 |
| Properties | | | | | |
| Rolling resistance | % | 100 | 103 | 100 | 109 |
| Wet braking | % | 100 | 103 | 100 | 102 |
| Dry braking | % | 100 | 101 | 100 | 101 |

^{b}functionalized polybutadiene A according to experimental description, cis content: 30% by weight, trans content: 40% by weight, vinyl content: 30% by weight, amine functionalization: piperazine group, M_{w} = 361 000 g/mol, Tg = −75° C.
^{c}functionalized polybutadiene B according to EP 2 853 558 A1, cis content: 39% by weight, trans content: 51% by weight, vinyl content: 8% by weight, functionalized with (MeO)₂(Me)Si—(CH₂)₂—S—SiMe₂C(Me)₃ and (MeO)₃Si—(CH₂)₂—S—SiMe₂C(Me)₃, M_{w} = 501 000 g/mol, Tg = −94° C.
^{d}Sprintan ® SLR3402, Trinseo, Germany, functionalized solution-polymerized styrene-butadiene copolymer

It can be inferred from table 2 that the specially functionalized polybutadiene A with the organosilyl group containing amino groups and/or ammonium groups at one chain end and the amino group at the other chain end leads to a distinct improvement in rolling resistance. This specific functionalization gives rolling resistance values above those that are achieved with another functionalized polybutadiene having groups without nitrogen. At the same time, it is also possible to improve wet braking characteristics and dry braking characteristics, which was not to be expected, since an improvement in rolling resistance is typically associated with a deterioration in braking characteristics.

1.-12. (canceled)

13. A sulfur-crosslinkable rubber mixture comprising:
10-60 phr (parts by weight, based on 100 parts by weight of the total rubbers in the mixture) of at least one functionalized polybutadiene A;
up to 90 phr of at least one further diene rubber; and,
30-350 phr of at least one filler;
wherein the functionalized polybutadiene A is functionalized at one chain end with an organosilyl group containing amino groups and/or ammonium groups, and wherein the functionalized polybutadiene A is functionalized at the other chain end with an amino group.

14. The sulfur-crosslinkable rubber mixture as claimed in claim 13, wherein the functionalized polybutadiene A is a polybutadiene produced with a lithium catalyst.

15. The sulfur-crosslinkable rubber mixture as claimed in claim 13, wherein the functionalized polybutadiene A has a cis content of from 25% to 35% by weight.

16. The sulfur-crosslinkable rubber mixture as claimed in claim 13, wherein the functionalized polybutadiene A has a trans content of from 35% to 45% by weight.

17. The sulfur-crosslinkable rubber mixture as claimed in claim 13, wherein the functionalized polybutadiene A has a vinyl content of from 25% to 35% by weight.

18. The sulfur-crosslinkable rubber mixture as claimed in claim 13, wherein the functionalized polybutadiene A has a cis content of from 25% to 35% by weight, a trans content of from 35% to 45% by weight and a vinyl content of from 25% to 35% by weight.

19. The sulfur-crosslinkable rubber mixture as claimed in claim 13, wherein the functionalized polybutadiene A has a molecular weight M_{w} of from 250,000 to 500,000 g/mol.

20. The sulfur-crosslinkable rubber mixture as claimed in claim 19, wherein the molecular weight M_{w} is from 300,000 to 400,000 g/mol.

21. The sulfur-crosslinkable rubber mixture as claimed in claim 20, wherein the molecular weight M_{w} is 361,000 g/mol.

22. The sulfur-crosslinkable rubber mixture as claimed in claim 13, wherein the functionalized polybutadiene A has a glass transition temperature of from −100 to −60° C.

23. The sulfur-crosslinkable rubber mixture as claimed in claim 22, wherein the glass transition temperature is 75° C.

24. The sulfur-crosslinkable rubber mixture as claimed in claim 13, wherein the amino group at the other chain end is a cyclic diamine group.

25. The sulfur-crosslinkable rubber mixture as claimed in claim 13, wherein the further diene rubber is selected from the group consisting of natural polyisoprene, synthetic polyisoprene, styrene-butadiene copolymers and further polybutadienes.

26. The sulfur-crosslinkable rubber mixture as claimed in claim 13, wherein the at least one filler is silica.

27. The sulfur-crosslinkable rubber mixture as claimed in claim 27, wherein the rubber mixture contains from 40 to 150 phr of the silica.

28. A pneumatic vehicle tire having at least one rubber component composed of the sulfur-vulcanized rubber mixture as claimed in claim 13.

29. The pneumatic vehicle tire as claimed in claim 28, wherein the rubber component is a part of a tread that comes into contact with a road.

30. The pneumatic vehicle tire as claimed in claim 28, wherein the rubber component is a body component.
